(19) United States
(12) Patent Application Publication
(10) Pub. No.: US 2024/0269643 A1
(43) Pub. Date: Aug. 15, 2024

(54) A CATALYTIC REACTOR AND A METHOD FOR PROVIDING A CATALYTIC REACTION

(71) Applicant: Catator AB, Lund (SE)

(72) Inventor: Fredrik SILVERSAND, Löddeköpinge (SE)

(73) Assignee: Catator AB, Lund (SE)

(21) Appl. No.: 18/566,941

(22) PCT Filed: Jun. 9, 2022
(86) PCT No.: PCT/SE2022/050565

§ 371 Date: Dec. 4, 2023

(30) Foreign Application Priority Data
Jun. 14, 2021 (SE) 2150761-1

(51) Int. Cl. B01J 19/24; B01D 53/86; B01D 53/88; B01J 35/54; F23C 13/08

(52) U.S. Cl. CPC B01J 19/249; B01D 53/864; B01D 53/885; B01J 35/54; F23C 13/08; B01D 2257/502; B01D 2257/702; B01D 2257/708; B01D 2258/0283; B01J 2219/246; B01J 2219/247; B01J 2219/2479; F23C 2900/13001

(57) ABSTRACT

A catalytic reactor (22) comprising a central axis (A) and a stack of catalytically active sheets (10), wherein the catalytically active sheets (10) are stacked in the axial direction. Each of the catalytically active sheets (10) comprises a central opening (17) and at least some of the catalytically active sheets (10) comprise an axially extending flange (18) arranged at least partially around said central opening (17), wherein the flange (18) of one catalytically active sheet (10) extends into the central opening (17) of an adjacent catalytically active sheet (10). Disclosed is also a method for providing a catalytic reaction.

### TECHNICAL FIELD

The invention relates to a catalytic reactor and a method for providing a catalytic reaction. More specifically, the present invention is related to a catalytic reactor comprising a stack of catalytically active sheets. Catalytic reactors are used for various types of chemical reactions, including combustion, catalytic partial oxidation, catalytic reforming, autothermal reforming, hydrogenation, selective oxidation, etc. For example, catalytic reactors of this type can be used for combustion of gaseous fuels, such as natural gas, propane, butylene or similar gases or mixtures of different types of gaseous fuels.

### BACKGROUND

A plurality of different types of catalytic reactors are known in the prior art. One type of catalytic reactor is disclosed in WO9702092A1. WO9702092A1 describes a catalytic reactor, wherein gases to be reacted are conducted through catalytically active nets arranged in series.

One problem of catalytic reactors and methods for providing catalytic reaction according to the prior art is that they are inefficient.

Another problem of such prior art catalytic reactors and methods is that they lack flexibility and are difficult to dimension according to different applications and process parameters.

Another problem of such prior art catalytic reactors and methods is that they do not use the catalytically active material in an efficient manner and require vast amounts of such catalytically active material.

### SUMMARY

An object of the present invention is to overcome or at least alleviate one or more of the problems of prior art catalytic reactors and methods for providing catalytic reactions.

The present invention is related to a catalytic reactor comprising a central axis and a stack of catalytically active sheets, wherein the catalytically active sheets are stacked in the axial direction, characterised in that each of the catalytically active sheets comprises a central opening and at least some of the catalytically active sheets comprise an axially extending flange arranged at least partially around said central opening, wherein the flange of one catalytically active sheet extends into the opening of an adjacent catalytically active sheet. The combination of the central opening and the flange of the catalytically active sheets makes it possible to guide a first reactant in the axial direction along the stack while distributing the first reactant in the radial direction along the catalytically active sheets to react with a second reactant, which second reactant e.g. is conducted in the axial direction in a position radially outside the central opening. Hence, the invention results in an efficient reactor, wherein the concentration of the first reactant is higher closer to the central opening and lower further out in the radial direction. In this manner, the reactor is flexible and can be used for different types of reactions and can be adapted to different process parameters. For example, the catalytic reactor can be used for combustion, catalytic partial oxidation, catalytic reforming, autothermal reforming, hydrogenation, selective oxidation, etc. The structure of the reactor results in that the catalytically active material in the catalytically active sheets can be used efficiently. For example, the first reactant may be fuel, such as a mixture of gaseous fuels, e.g. in the form of biofuels, and the second reactant may be air or oxygen, wherein an efficient reactor for combustion of such a mixture of fuels is achieved.

Each of the catalytically active sheets can comprise a radially extending portion extending in the radial direction from the central opening. The radially extending portion of one catalytically active sheet may be arranged with a gap to the radially extending portion of an adjacent catalytically active sheet. Hence, the first reactant can be distributed into the gaps for efficient reaction with the second reactant along the radially extending portions of the catalytically active sheets.

The flange may be tapering towards a free end thereof, wherein the catalytically active sheets can be stacked in an efficient manner, e.g. to provide the gap between the radially extending portions of adjacent catalytically active sheets.

The catalytically active sheets may be arranged in a mesh structure, such as a wire mesh, perforated plate material, expanded metal or similar, wherein the first reactant can be guided in the axial direction through the stack by means of the cooperating flanges while some of the first reactant is guided through the flanges in the radial direction in a balanced manner by means of the openings in the mesh structure. The flange and the radially extending portion may be formed in the mesh structure. Hence, the second reactant can efficiently be conducted through the radially extending portions of the stack in the axial direction. For example, the entire catalytically active sheet is formed in the mesh structure.

Alternatively, the catalytically active sheets may be formed in a plate material, such as sheet metal, wherein the flanges may be provided with holes and/or the radially extending portions may be provided with through apertures distributed around the central opening. Hence, the first reactant can be guided in the axial direction through the stack by means of the cooperating flanges while some of the first reactant is guided through the flanges in the radial direction in a balanced manner by means of the holes in the flanges. The second reactant can efficiently be conducted through the radially extending portions of the stack in the axial direction by means of the apertures to react with the first reactant guided in the gaps in the radial direction outward along the radially extending portions.

The stack of catalytically active sheets, or at least the central opening, may be blocked in one end. By blocking the central opening or the stack in an end opposite the end where the first reactant is introduced results in an efficient distribution of the first reactant in the stack. The first reactant is guided through the stack in the axial direction by means of the cooperating flanges and by blocking the end the first reactant is forced in the radial direction.

The catalytically active sheets may comprise a substrate and a ceramic layer adhered to the substrate, wherein the ceramic layer is formed with pores provided with a catalytically active material. The catalytically active sheet may also comprise a first material and particles of a second material having higher melting point than the first material, wherein the ceramic layer is adhered to the substrate through the first material and particles of the second material being partially embedded in the first material and projecting into the ceramic layer. In this manner, the ceramic layer with the catalytically active material is efficiently adhered to the substrate, such as a mesh structure, a plate or similar.

The catalytic reactor may comprise a reactor vessel having an inlet for the first reactant, at least one inlet for the second reactant, and at least one outlet, wherein the stack of catalytically active sheets is arranged inside the reactor vessel, wherein the inlet for the first reactant is arranged at one end of the stack and is aligned with the central openings of the catalytically active sheets, and wherein at least the central opening is blocked at the opposite end of the stack.

The present invention is also related to a method for providing a catalytic reaction, comprising the steps of
a) feeding a first reactant in an axial direction into a central opening of a catalytically active sheet of a stack of catalytically active sheets,
b) guiding some of the first reactant through an axially extending flange arranged at least partially around some of said openings and further into the central opening of an adjacent catalytically active sheet in the axial direction, and
c) guiding some of the first reactant radially outward from the flange and into contact with a second reactant to provide the catalytic reaction.

Disclosed is also a method of producing a catalytically active sheet, comprising the steps of:
a) providing a substrate,
b) depositing a first material and particles of a second material on the substrate, wherein the particles of the second material have a higher melting point than the first material,
c) heating the substrate with the first material and said particles to a temperature where the first material is melted and the particles of the second material are not melted and thereby adhering the first material and the particles to the substrate, wherein particles are partly embedded in the first material and form a rough surface,
d) depositing a ceramic material on the rough surface formed by the particles to form a ceramic layer thereon, and
e) adding a catalytically active material to the ceramic layer.

The method of producing the catalytically active sheet results in an easy and efficient production of the catalytically active sheet. The production method makes it possible to produce the catalytically active sheet without any thermal spraying process. The combination of the first material and the particles result in a safe, reliable and efficient securing of the ceramic layer to the substrate for the production of the catalytically active sheet.

The method can comprise the step of providing the first material and/or the particles of the second material as one or more suspensions, optionally both are provided in combination as a suspension. Hence, the first material and/or the second material can be deposited on the substrate in an efficient manner, such as by spraying or other coating process, wherein the suspension can be deposited at any suitable temperature, such as at room temperature. Hence, the first material can initially be deposited on the substrate without melting. Then, the method can include the step of heating the substrate with the first material and the particles of the second material thereon in a furnace, such as a vacuum furnace or with reducing or inert gas, for melting the first material only and adhere the first material to the substrate while securing the particles to the first material. Hence, the first material and the particles efficiently form an attachment layer for subsequent fastening of the ceramic layer, which can be produced in an efficient and reliable manner.

After securing the first material to the substrate by melting it, the method can comprise the step of depositing the ceramic layer by providing a ceramic material as a suspension and depositing the suspension onto the first material with the particles, e.g. by spraying. Hence, the ceramic material is formed in an easy manner and partially enclose the particles projecting from the first material to reliably secure the ceramic layer mechanically to the substrate, e.g. by drying and calcination.

Further characteristics and advantages of the present invention will become apparent from the description of the embodiments below, the appended drawings and the dependent claims

### BRIEF DESCRIPTION OF THE DRAWINGS

By way of example, embodiments of the present invention will now be described with reference to the accompanying drawings, in which:

FIG. 1 is an enlarged and schematic cross-section illustration of a part of a catalytically active sheet according to the present invention,

FIGS. 2-6 is a series of schematic cross-section illustrations of a method of producing the catalytically active sheet of FIG. 1 according to a first embodiment,

FIGS. 7-11 is a series of schematic cross-section illustrations of a method of producing the catalytically active sheet of FIG. 1 according to a second embodiment FIG. 12 is a schematic view of a catalytically active sheet according to one embodiment, wherein the catalytically active sheet is arranged with a flange and is arranged in the form of a mesh,

FIG. 13 is a schematic side view of the catalytically active sheet of FIG. 12,

FIG. 14 is a schematic side view of a stack of catalytically active sheets of FIG. 12,

FIG. 15 is a schematic view of a catalytically active sheet according to another embodiment, wherein the catalytically active sheet is in the form of a plate with apertures and with holes in the flange,

FIG. 16 is a schematic side view of the catalytically active sheet of FIG. 15,

FIG. 17 is a schematic side view of a stack of catalytically active sheets of FIG. 15,

FIG. 18 is a schematic section view of a catalytic reactor according to a first embodiment of the present invention,

FIG. 19 is a schematic section view of a catalytic reactor according to FIG. 18, illustrating flows of reactants and product inside the catalytic reactor,

FIG. 20 is a schematic section view of the catalytic reactor according a second embodiment of the present invention, and

FIG. 21 is a schematic section view of the catalytic reactor according to the FIG. 20, illustrating flows of reactants and product inside the catalytic reactor.

### DETAILED DESCRIPTION OF THE EMBODIMENTS

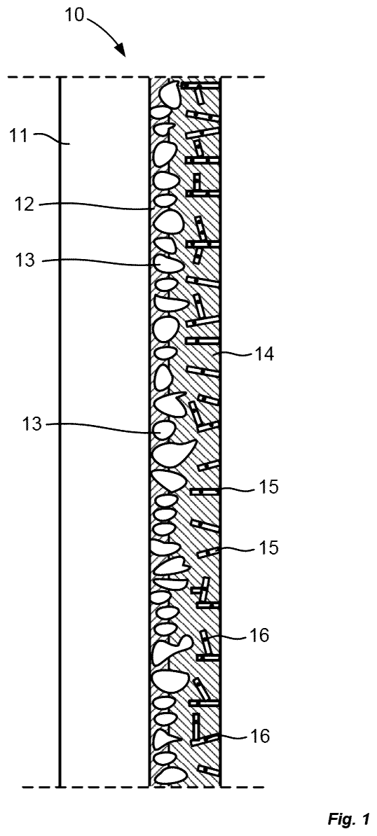

With respect to FIG. 1, a catalytically active sheet 10 is illustrated schematically according to the present invention. The catalytically active sheet 10 is configured to be used for promoting a chemical reaction. For example, the catalytically active sheet 10 is arranged for combustion, purification, catalytic reforming or similar. For example, the catalytically active sheet 10 is arranged for purification of flue gases with respect to carbon monoxide and/or hydrocarbons, such as VOC and PAH. For example, the catalytically active sheet 10 is part of a reactor and may be arranged in a reactor vessel for a chemical reaction, which will be describe below. For example, the catalytically active sheet 10 included in a reactor for combustion of gaseous fuels, such as natural gas, propane, butylene or similar gases or mixtures of different fuels, e.g. for heating purposes.

The catalytically active sheet 10 comprises a substrate 11, a first material 12, particles 13 of a second material, a ceramic layer 14 comprising a ceramic material with pores 15, and a catalytically active material 16. The first material 12 and the particles 13 form an attachment layer on the substrate 11. For example, the first material 12 is arranged directly on top of the substrate 11, wherein the particles 13 are partially embedded in the first material 12 and projects from the surface thereof. The ceramic layer 14 is arranged on top of the attachment layer formed by the first material 12 and the particles 13, wherein the ceramic layer 14 engages the particles 13. Hence, the attachment layer formed by the first material 12 and the particles 13 is arranged between the substrate 11 and the ceramic layer 14.

According to one embodiment, the catalytically active sheet 10 is formed as a mesh structure, i.e. having a plurality of through holes. For example, the substrate 11 is formed as a wire mesh, grid or similar. Alternatively, the substrate 11, and thus also the catalytically active sheet 10, is formed as a plate sheet provided with holes, which will be described more in detail below. For example, the substrate 11 is or comprises a metal or an alloy. According to one embodiment, the substrate is made of steel, such as stainless steel, aluminum or copper. Alternatively, the substrate 11 is made of a polymer material, such as polytetrafluoroethylene or similar polymer or composite materials that can withstand relatively high temperatures. In general, the substrate 11 should be able to withstand temperatures of at least 350° C. In some cases, it should be able to withstand temperatures well above this level, such as at least 500° C., at least 700° C. or at least 900° ° C.

On top of the substrate 11, which forms a base structure, the first material 12 is arranged. The substrate 11, or at least a portion or a side thereof, is coated with the first material 12. In the illustrated embodiment, a top surface of the substrate 11 is coated with the first material 12. Alternatively, opposite sides or all sides or the entire substrate 11 is coated with the first material 12. For example, the first material 12 is a metal or an alloy. For example, the first material 12 is Al or similar metal having a relatively low melting point. Alternatively, the first material 12 is an alloy comprising a metal, such as Ni, Cu, Fe and/or steel, and a melting point depressant.

The particles 13 are partially embedded in the first material 12 and project at least partially from it in a direction away from the substrate 11. The particles 13 are made of or comprises a second material having a higher melting point than the first material 12. For example, the solidus temperature of the particles 13 of the second material is higher than the liquidus temperature of the first material 12. For example, the particles 13 of the second material comprise metal powder, ceramic powder or mixtures thereof. The particles 13 may have different shapes and sizes. The particles 13 are provided in or on the first material 12 to add surface roughness which helps in the adhesion of the ceramic layer 14. For example, the particles 13 have a particle size of at least 10 μm, or at least 20 μm, such as 20-100 μm. For example, the second material has a porosity of at least 30%.

The ceramic layer 14 is provided on the attachment layer formed by the first material 12 and the particles 13 and is secured to it by means of the particles 13. Hence, particles 13 are partially embedded in the first material 12 and partially embedded in the ceramic layer 14 to mechanically fasten the ceramic layer 14 to the substrate 11. Hence, the ceramic layer 14 is arranged on top of the first material 12 and the particles 13 projecting from it. The ceramic layer 14 may comprise alumina, zirconia, titanium dioxide, silica, tungsten carbides, silicon nitrides or similar ceramics, or mixtures thereof. The ceramic layer 14 is formed with pores 15 providing an enlarged surface area for depositing the catalytically active material 16 therein. Hence, the ceramic layer 14 is provided with the catalytically active material 16, wherein catalytically active material 16 is arranged inside the pores 15 thereof. For example, the catalytically active material 16 is a noble metal, a transition metal or a mixture or an oxide thereof. For example, the catalytically active material 16 is palladium.

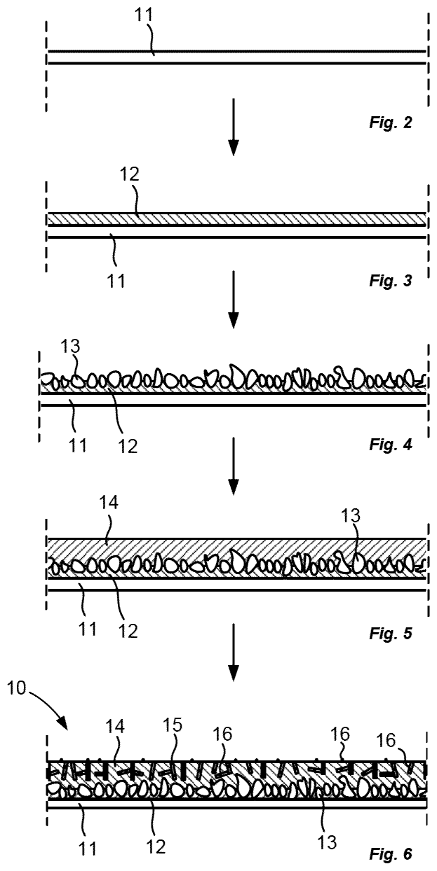

With reference also to FIGS. 2-6 a method of producing the catalytically active sheet 10 is illustrated schematically according to a first embodiment by means of a series of illustrations. The substrate 11 has been described above and is illustrated schematically in FIG. 2. The substrate 11 is coated with the first material 12, e.g. through a spraying process. The substrate 11 with the first material 12 is illustrated in FIG. 3, wherein the first material 12 is provided as a layer on the substrate 11. According to one embodiment, the first material 12 is provided as a suspension, wherein the first material 12 is provided as particles dispersed in a liquid, such as water. For example, the substrate 11 is coated with the first material 12 through a spraying process, wherein the first material 12 is sprayed onto the substrate 11, e.g. in room temperature. Hence, the first material 12 is not heated and is not sprayed at elevated temperatures. Alternatively, the first material 12 is applied on the substrate 11 by another coating process, such as painting, dipping or similar. Alternatively, the first material 12 is provided as a paste, which is applied onto the substrate 11 by spreading over the surface of the substrate 11. After applying the first material onto the substrate, the substrate 11 with the first material 12 is optionally dried, e.g. by heat treatment in an oven.

After coating of the substrate 11 with the first material 12, the particles 13 comprising the second material is provided on the first material 12, which is illustrated in FIG. 4. For example, the particles 13 are provided as a suspension, also called slurry, wherein the particles 13 are suspended in liquid, such as water. The suspension of the particles 13 is applied on the first material 12 carried by the substrate 11. For example, the particles 13 are applied onto the first material 12 through a spraying process, wherein the suspension with the particles 13 is sprayed on the first material 12. Hence, the particles 13 may be sprayed onto the first material 12 at room temperature. After applying the particles 13 onto the first material 12, the substrate 11 carrying the first material 12 and the particles 13 may be dried, e.g. in an oven. The substrate 11 with the first material 12 and the particles 13 is then heat treated, e.g. in a furnace, to a temperature, wherein the first material 12 is melted and the particles 13 of the second material are not melted. Neither is the substrate 11 melted. Hence, the first material 12 is secured to the substrate 11 by melting while securing the particles 13 to the first material 12. The particles 13 are secured to the first material 12 mechanically, wherein the particles 13 are partly embedded in the first material 12 after melting of the first material 12. The first material 12 is also adhered to the substrate mechanically by melting into a roughness of its surface. Particles 13 partly embedded in the first material 12 and projecting from it are illustrated in FIG. 4. For example, the heat treatment for melting the first material 12 is performed in a vacuum furnace under vacuum. Alternatively, the heat treatment for melting the first material 12 is performed in a furnace with reducing gas or an inert gas.

The substrate 11 carrying the first material 12 and the particles 13 is then provided with the ceramic layer 14, which is illustrated in FIG. 5, wherein the ceramic layer 14 is provided onto the particles 13 and the first material 12, so that the first material 12 is arranged between the ceramic layer 14 and the substrate 11. For example, the ceramic layer 14 is deposited onto the attachment layer 12 as a slurry, such as in the form of a water based suspension. The ceramic layer 14 may also contain a pore-forming agent which is provided to form a porous structure in the ceramic material. Typically, the thickness of the ceramic layer is in the range of 0.1-0.8 mm, preferably in the range of 0.2-0.5 mm. The ceramic layer 14 is surface enlarged by the pores 15, which are configured to hold the catalytically active material 16, which is illustrated in FIG. 6.

The ceramic layer 14 may be produced according the following process, 1) direct spraying together with secondary surface area enlargement through precipitation, or 2) spraying with simultaneous depositing of ceramic powder, or a combination of methods 1) and 2), followed by coating with a catalytically active material 16 through an impregnation process. Alternatively, the pore-forming agent may be a combustible material which may be combusted by heat treatment. Optionally, the pore-forming agent may be a pore-forming polymer material. Alternatively, the ceramic layer 14 is a ceramic powder containing particles with a high specific surface. For example, the pores 15 are formed in the ceramic layer 14 in a conventional manner.

The pores 15 of the ceramic layer 14 are configured to carry the catalytically active material 16. For instance, the pores 15 may be cylindrically shaped. This way, chemicals to be purified can easily reach the catalytically active material 16 of the catalytically active sheet 10. The catalytically active material 16 may be deposited in the pores 15 of the ceramic layer for instance through a conventional impregnation process. During impregnation, the structure of pores 15 of the ceramic layer 14 is, e.g. saturated with a solution containing the catalytically active material 16. The catalytically active material 16 may include noble metals, transition metals or combinations of these.

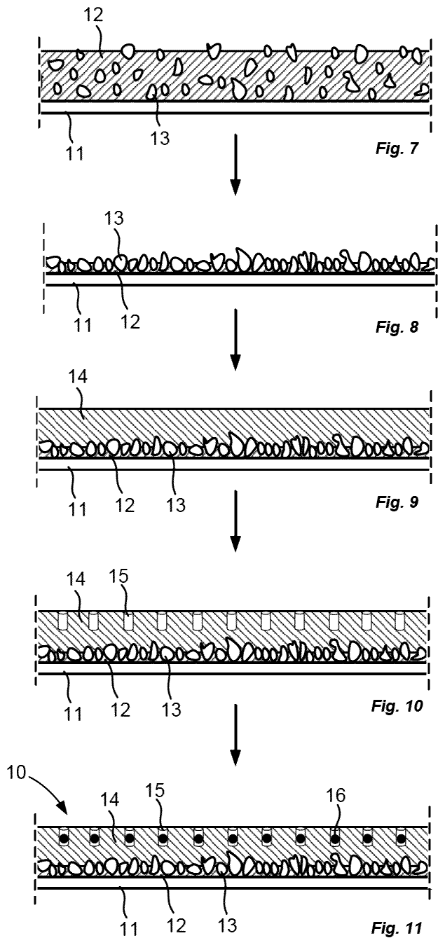

With reference to FIGS. 7-11 an alternative embodiment of the present invention is described, wherein the substrate 11 is coated with a mix of the first material and the particles 13 of the second material. The substrate 11 with the mix of the first material 12 and the particles 13 is illustrated in FIG. 7. For example, also the first material 12 is provided as particles, wherein the first material 12 and the particles 13 of the second material are provided as a mix in a slurry. The slurry comprising both the first material 12 and the particles 13 of the second material is applied on the substrate 11, e.g. by spraying, as described above. Hence, the slurry may be provided on the substrate by spraying in room temperature. Then, the substrate 11 with the slurry is optionally dried. After, coating the substrate 11 with the mixture of the first material 12 and the particles 13, it is heated to melt the first material 12 but not the substrate 11 or the second material, wherein the particles 13 are adhered to the first material 12 and the first material 12 is adhered to the substrate 11, as illustrated in FIG. 8. Hence, particles 13 are partially embedded in the first material 12 and project from it in a direction away from the substrate 11 to obtain a rough outer surface for securing the ceramic layer 14 as describe above. Then, the ceramic layer 14, which may be provided as a slurry, is deposited onto the first material 12 and the particles 13 as illustrated in FIG. 9. For example, the ceramic layer may be deposited by spraying as described above. Then, the ceramic layer 14 may be subjected to a surface area enlarging process to form the pores 15, as illustrated in FIG. 10. For example, the ceramic layer 14 contains a pore-forming agent. Finally, the catalytically active material 16 is deposited through for instance impregnation. The catalytically active material 16 may be deposited on the surface of the ceramic layer 14 and inside the pores 15 thereof.

The particles are provided in the first material 12 to add surface roughness which helps in the adhesion of a subsequently arranged ceramic layer 14. Put differently, by providing coarse particles in the first material 12, an enlarged surface for improved adhesion of the ceramic material 14 to the substrate 11 can be realized. When heated, the first material 12 is fused to the substrate 11 and the contained particles 13 are exposed. By exposing the particles 13 the ceramic layer 14 may be secured to the substrate 11. This is due to the enlarged surface area and roughness provided by the particles 13.

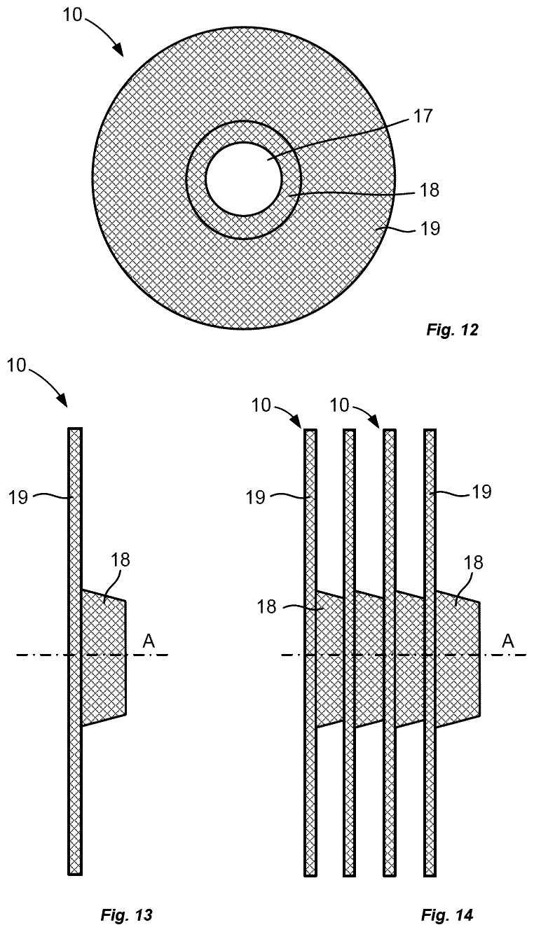

With reference to FIGS. 12 and 13 the catalytically active sheet 10 is illustrated schematically according to one embodiment of the present invention and FIG. 14 illustrates a stack of such catalytically active sheets 10. FIG. 14 illustrates four identical catalytically active sheets 10 but the stack may contain any suitable number of catalytically active sheets 10 and they do not need to be identical. For example, the catalytically active sheet 10 is arranged with at least the substrate 11 and the catalytically active material 16 and optionally also with one or more of the ceramic layer 14, the first material 12 and the second material 13. For example, the catalytically active sheet 10 is arranged as describe above with reference to FIG. 1.

The catalytically active sheet 10 is arranged with an axis A, a through central opening 17, a central flange 18 arranged at least partially around said central opening 17 and extending at least partially in the axial direction, and a radially extending portion 19. In the illustrate embodiment, the central opening 17 is circular. Alternatively, the central opening 17 is oval or rectangular or formed in another suitable manner. In the illustrated embodiment, the flange 18 is continuous and surrounds the entire circumference of the central opening 17. Alternatively, the flange 18 is interrupted or arranged as two or more tabs distributed around the central opening 17.

With reference particularly to FIGS. 13 and 14 the flange 18 extends in the axial direction, wherein the radially extending portion 19 extend in the radial direction from a base of the flange 18. For example, the base of the flange 18 is connected to the radially extending portion 19 and is terminated in a free end. For example, the base and/or the free end of the flange 18 is annular, e.g. with a circular cross section but the flange 18 or at least the base thereof may have a shape corresponding to other shapes of the central opening 17. At least a portion of the flange 18 can be inserted into the flange 18 of an adjacent catalytically active sheet 10 as illustrated in FIG. 14. For example, the flange 18 is tapering towards its free end, wherein the free end of a flange 18 can be inserted into the base of an adjacent catalytically active sheet's flange 18. Hence, a diameter or cross section area of the base of the flange 18 is bigger than at the free end thereof. For example, the flange 18 is conical, or more specifically frustoconical.

In the illustrated embodiment, the radially extending portion 19 is extending in the radial direction from the base of the flange 18. For example, the radially extending portion 19 is a sheet or sheet portion with the central opening 17. For example, the radially extending portion 19 extends from the central opening 17 to the periphery of the catalytically active sheet 10 and is a free end, wherein the outer periphery of the radially extending portion 19 also forms the free outer periphery and free of the catalytically active sheet 10. In the illustrated embodiment, the radially extending portion 19 is flat and extends only in the radial direction and perpendicular from the axis A throughout its length. Alternatively, the radially extending portion 19 partially in the radial direction and is inclined in relation to the axis A, wherein the radially extending portion 19 is tapering towards the central opening 17. Alternatively, the radially extending portion 19 is formed with varying structure, such as with dents, waves or similar, optionally fitting into similar shapes of adjacent catalytically active sheets 10. Hence, the catalytically active sheets 10 are stackable. For example, the catalytically active sheets 10 are formed so that the flanges 18 contact each other when they are stacked, while the radially extending portions 19 are arranged with a gap between each other as illustrated in FIG. 14. For example, the catalytically active sheets 10 are stacked and then pressed together. In the embodiment of FIGS. 12-14 the catalytically active sheets 10 are arranged with a mesh structure, such as a wire mesh, net or grid structure, perforated sheet or expanded metal sheet. For example, the mesh openings are not more than 2 mm, such as 0.1 to 2 mm.

In the illustrated embodiment, all catalytically active sheets 10 in the stack are arranged with the flange 18. Alternatively, at least some of the catalytically active sheets 10 comprise the axially extending flange 18, wherein the flange 18 of one catalytically active sheet extends into the central opening 17 of an adjacent catalytically active sheet 10. For example, every other catalytically active sheet 10 in a stack of sheets comprises the flange 18. For example, the flanges 18 cooperate to form a central tubing through the stack.

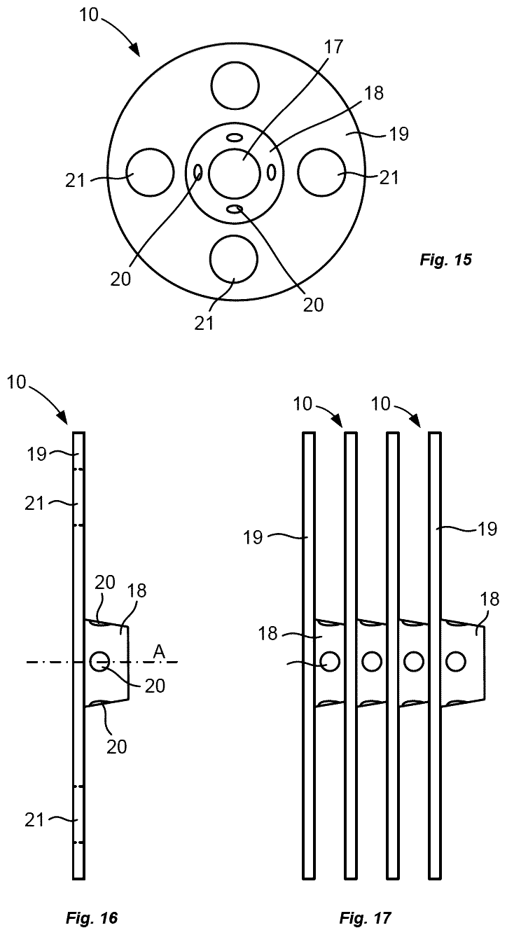

With reference to FIGS. 15 and 16 the catalytically active sheet 10 is illustrated schematically according to another embodiment of the present invention and FIG. 17 illustrates a stack of such catalytically active sheets 10. The catalytically active sheet 10 according to FIGS. 15-17 differs from the catalytically active sheet of FIGS. 12-14 in that it is not formed with a mesh structure but is formed from a continuous sheet, such as sheet metal or other suitable sheet material. The catalytically active sheet 10 is arranged with the axis A, the through central opening 17, the central flange 18 and the radially extending portion 19. In the embodiment of FIGS. 15-17, the axially extending flanges 18 form a conduit as seen in FIG. 17. Hence, each flange 18 is provided with through holes 20, such as at least two or at least four or six holes 20, distributed around the periphery of the flange 18 and connected the conduit formed by the flanges 18 and the spaces formed by the gaps between the radially extending portions 19. In addition, the radially extending portions 19 are arranged with through apertures 21, such as at least two or at least four or six through apertures 21, distributed around the central opening 17. Two apertures 21 are illustrated by dashed lines in FIG. 16. For example, the through apertures 21 are arranged between the central opening 17 and the periphery of the radially extending portion 19. For example, the apertures 21 of adjacent catalytically active sheets 10 are aligned. In the illustrated embodiment, the apertures 21 are distributed around the central opening 17 in a similar manner as the holes 20, wherein the apertures 21 and the holes 20 are arranged at the same radial angles in relation to the axis A. For example, an extension of a centre axis of a hole 20 intersects a corresponding extension of a centre axis of an aperture 21. The apertures 21 are arranged for providing an axial flow, wherein the holes 20 are arranged for providing a substantially radial flow. For example, the holes 20 are positioned so that the radial flow intersects the axial flow through the apertures 21. In the illustrated embodiment, the apertures 21 extend in a radial plane. Optionally, the apertures 21 are bigger than the holes 20. In the drawings, the apertures 21 and the holes 20 are circular but they may have other shapes, such as oval, rectangular or other suitable shapes. The holes 20 are positioned so as not to be blocked when the catalytically active sheets 10 are stacked. According to one embodiment, the holes 20 are positioned closer to the base of the flange 18 than to the free end thereof.

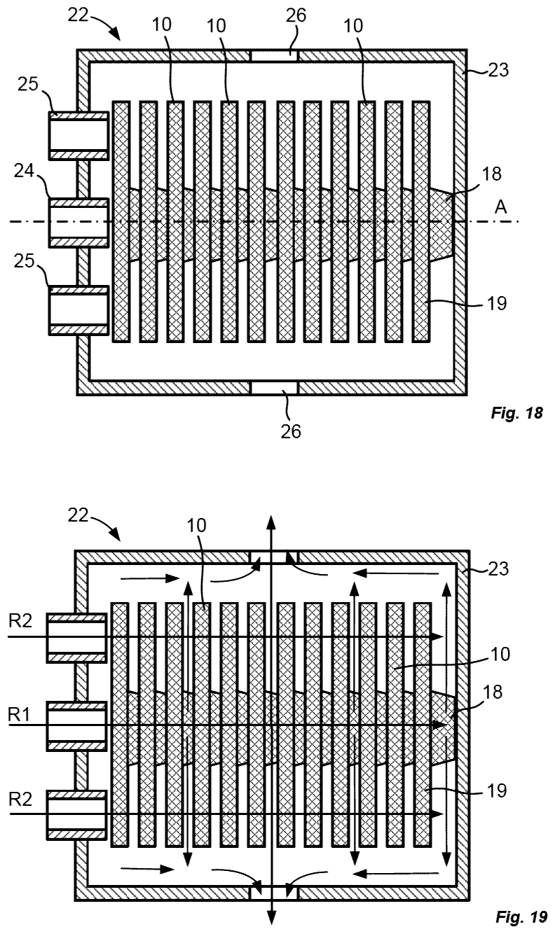

With reference to FIGS. 18 and 19 a catalytic reactor 22 is illustrated schematically according to a first embodiment. The catalytic reactor 22 comprises a stack of catalytically active sheets 10. The catalytically active sheets 10 comprise the central opening 17 and at least some of the catalytically active sheets in the stack comprise the axially extending flange arranged at least partially around said central opening 17, wherein the flange 18 of one catalytically active sheet 10 extends into the central opening 17 of an adjacent catalytically active sheet 10. In FIGS. 18 and 19 the catalytically active sheets 10 are illustrated with a mesh structure. For example, the catalytically active sheets 10 are arranged as described with reference to FIGS. 12-14. Alternatively, the catalytically active sheets 10 are formed of plate material with the apertures 21 in the radially extending portion 19, wherein at least some of the catalytically active sheets 10 are formed with the flange 18 with the holes 20 as described with reference to FIGS. 15-17.

In the illustrated embodiments, the catalytic reactor 22 comprises an optional reactor vessel 23, wherein the stack of catalytically active sheets 10 is arranged inside the reactor vessel 23. The reactor vessel 23 is arranged with an inlet 24 for a first reactant. For example, the first reactant is fuel, such as a gaseous fuel. According to one embodiment, the first reactant is a mixture of fuels. The inlet 24 for the first reactant is arranged for conducting the first reactant to the central opening 17 of the catalytically active sheets 10. For example, the inlet 24 for the first reactant is aligned with the central openings 17. In the illustrated embodiment, the inlet 24 for the first reactant is arranged at a first end of the reactor vessel 23, such as centrally at the first end. The reactor vessel 23 is arranged with one or more inlets 25 for a second reactant. For example, the second reactant is air or oxygen. For example, the reactor vessel 23 is arranged with at least two, or at least four or six or more inlets 25 for the second reactant, arranged radially outside the inlet 24 for the first reactant. In the embodiment of FIGS. 18 and 19 the inlets 25 for the second reactant are arranged in the first end of the reactor vessel 23, i.e. the same end as the inlet 24 for the first reactant. The inlets 25 for the second reactant are distributed around the inlet 24 for the first reactant. For example and if applicable, the inlets 25 for the second reactant may be aligned with the apertures 21 in the radially extending portion 19 of the catalytically active sheets 10. The reactor vessel 23 is also arranged with one or more outlets 26 for the product. For example, the product is combustion gases, e.g. including carbon dioxide. In the illustrated embodiment, the outlets 26 are arranged radially outside the stack of catalytically active sheets 10 but may be positioned in any suitable place. A second end of the reactor vessel 23 is blocked, or at least the end of the stack of catalytically active sheets 10 opposite the inlet 24 for the first reactant is blocked.

With reference to FIG. 19 flows of the first and second reactants and the product are illustrated schematically. The first reactant is conducted into the central openings 17 of the catalytically active sheets 10 in an axial flow, which is illustrated by the arrow R1. The first reactant is conducted into the central openings 17 in the axial direction at one end of the stack of catalytically active sheets 10. For example, the first reactant R1 is conducted into the reactor vessel 23 through the inlet 24 for the first reactant. Alternatively, the first reactant is conducted directly into the central opening 17 at one end of the stack. The first reactant R1 is guided through the central openings 17 by the flanges 18 to the opposite blocked end of the stack of catalytically active sheets 10, wherein the first reactant is forced radially outward, such as through the mesh of the flange 18 or the holes 20 thereof, and is forced in the radial direction, such as in the gaps between the radially extending portions 19 of the catalytically active sheets 10. A part of the flow of the first reactant is guided further in the axial direction by the flanges 18, wherein a part of the flow will be forced radially outward. For example, when a certain pressure is achieved inside the reactor vessel 23, the first reactant is forced radially outward. The radial flow of the first reactant through the flanges 18 and further outward is illustrated by means of arrows. Simultaneously, the second reactant is conducted in the axial direction through the radially extending portions 19, e.g. by the radially extending portions 19 being formed in a mesh material or through the apertures 21 thereof, which axial flow of the second reactant is illustrated by the arrows R2. For example, the second reactant R2 is conducted into the reactor vessel 23 through the inlets 25 for the second reactant. The first reactant, being forced in the radial direction, then collides with the axial flow of the second reactant R2 and the first and second reactant react to form the product. The product is then guided out from the reactor vessel 23 through the outlet(s) 26. Hence, the concentration of the first reactant is higher closer to the central opening 17 and the flange 18 than further outward in the radial direction, wherein the concentration of the first reactant is decreasing in the radial direction. At the same time, the concentration of the second reactant is higher further out in the radial direction in the stack of catalytically active sheets 10, such as at the radial level where it is fed into the stack of catalytically active sheets 10. For example, the concentration of the second reactant is increasing in the radial direction between the flange 18 and the radial level where the second reactant is introduced. The concentration of the product is, of course, increasing in the radial direction outward.

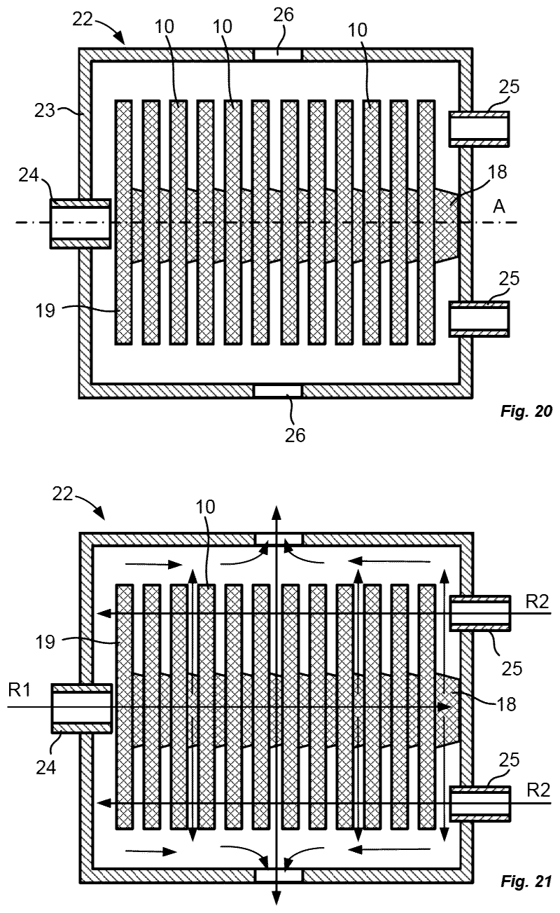

With reference to FIGS. 20 and 21 a second embodiment of the catalytic reactor 22 is illustrated schematically, wherein the inlets 25 for the second reactant are arranged in the second end of the reactor vessel 23, opposite the first end and opposite the inlet 24 for the first reactant. The inlets 25 are arranged radially outside of the central opening 17. Hence, the second reactant is conducted into the stack of catalytically active sheets 10 in an opposite axial direction as the first reactant, which is illustrated by the arrow R1 for the first reactant and the arrows R2 for the second reactant. The central opening 17 at the opposite end of the stack as the first reactant is introduced is blocked to force the first reactant in the radial direction into contact with the flow of the second reactant R2 to form the product as described above. Alternatively, the second end of the reactor vessel is blocked, apart from the inlets 25 for the second reactant, to force the first reactant in the radial direction.

The inlets 25 for the second reactant have been described above as a plurality of inlets distributed around the axis A of the stack of catalytically active sheets 10. Alternatively, the second reactant is conducted to the radially extending portion 19 at one end of the stack through an annular orifice or an annular inlet extending radially outside of the central opening 17.

1. A catalytic reactor comprising:
a stack of catalytically active sheets;
wherein the catalytically active sheets are stacked in an axial direction;
wherein each of the catalytically active sheets includes a central opening and at least some of the catalytically active sheets include an axially extending flange arranged at least partially around the central opening;
wherein the flange of one catalytically active sheet extends into the central opening of an adjacent catalytically active sheet.

2. The catalytic reactor according to claim 1, wherein each of the catalytically active sheets comprises a radially extending portion extending in a radial direction from the central opening.

3. The catalytic reactor according to claim 2, wherein the radially extending portion of one catalytically active sheet is arranged with a gap to the radially extending portion of an adjacent catalytically active sheet.

4. The catalytic reactor according to claim 2, wherein the radially extending portion is flat.

5. The catalytic reactor according to claim 2, wherein the radially extending portion extends from the central opening to a periphery of the catalytically active sheet.

6. The catalytic reactor according to claim 1, wherein the flange is tapering towards a free end thereof.

7. The catalytic reactor according to claim 1, wherein the flange extends continuously around the entire central opening.

8. The catalytic reactor according to claim 1, wherein the flange is provided with through holes.

9. The catalytic reactor according to claim 1, wherein each of the catalytically active sheets includes a radially extending portion that is provided with through apertures distributed around the central opening.

10. The catalytic reactor according to claim 1, wherein the catalytically active sheet is a mesh.

11. The catalytic reactor according to claim 1, wherein the catalytically active sheet is made of a plate material.

12. The catalytic reactor according to claim 1, wherein each of the catalytically active sheets comprises a substrate and a ceramic layer adhered to the substrate;
wherein the ceramic layer is formed with pores provided with a catalytically active material.

13. The catalytic reactor according to claim 12, wherein the catalytically active sheet comprises a first material and particles of a second material having a higher melting point than the first material;
wherein the ceramic layer is adhered to the substrate through the first material and the particles of the second material being partially embedded in the first material and projecting into the ceramic layer.

14. The catalytic reactor according to claim 1, comprising:
a reactor vessel having an inlet for a first reactant, at least one inlet for a second reactant, and at least one outlet;
wherein the stack of catalytically active sheets is arranged inside the reactor vessel;
wherein the inlet for the first reactant is arranged at one end of the stack and is aligned with the central openings of the catalytically active sheets, and wherein at least the central opening is blocked at an opposite end of the stack.

15. The catalytic reactor according to claim 14, wherein the inlet for the second reactant is arranged radially outside the inlet for the first reactant.

16. A method for providing a catalytic reaction, the method comprising:
a) feeding a first reactant in an axial direction into a central opening of a catalytically active sheet of a stack of catalytically active sheets;
b) guiding some of the first reactant through an axially extending flange arranged at least partially around some of the central openings and extending into the central opening of an adjacent catalytically active sheet in the axial direction; and
c) guiding some of the first reactant radially outward from the flange and into contact with a second reactant to provide the catalytic reaction.

17. The method for providing a catalytic reaction according to claim 16, further comprising feeding the second reactant into the stack of catalytically active sheets in the axial direction in a position radially outside the central opening.

18. The method for providing a catalytic reaction according to claim 17, further comprising feeding the first reactant into a reactor vessel through an inlet for the first reactant and to one end of the stack of catalytically active sheets in a position aligned with the central openings thereof; and
guiding the first reactant in a radial direction by blocking at least the central opening at an opposite end of the stack.
